(19) United States
(12) Patent Application Publication
(10) Pub. No.: US 2010/0096022 A1
(43) Pub. Date: Apr. 22, 2010

(54) Safety shutoff valve

(76) Inventors: Saeed Tozandehjani, Tehran (IR); Farshid Forouzbakhsh, TEHRAN (IR)

Correspondence Address: BARRY CHOOBIN, TALEGHANI, BAHARE SHOMALI , #219, SUITE#18, TEHRAN, 1563714311, IR

(21) Appl. No.: 12/603,880

(22) Filed: Oct. 22, 2009

Related U.S. Application Data
(60) Provisional application No. 61/107,356, filed on Oct. 22, 2008.

(51) Int. Cl. F16K 17/36

(52) U.S. Cl. 137/38

(57) ABSTRACT

It is disclosed a shut-off valve which acts automatically and has a fully mechanical performance with respect to the loosing of the tower-shape part balance under the effect of the special acceleration which is arisen from the quakes waves or serious vibrations, while such vibrations are mainly resulted from collision or effusion. A static tower has been applied for the main core of this part of the valve which loses balance state under the effect of collision and bounces to the neighboring part, which results in release of the catch and blockage of the gas passing channel.

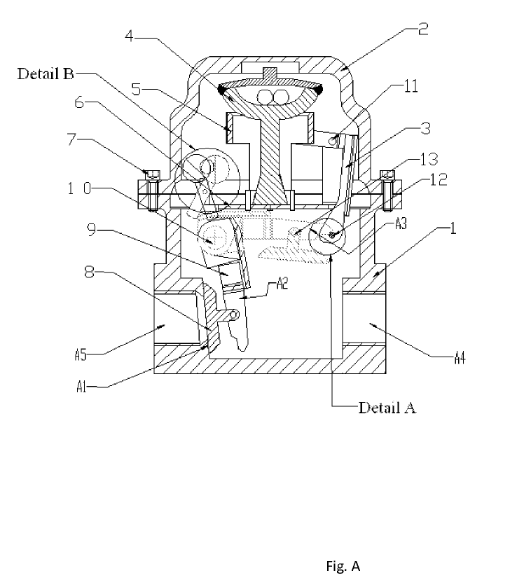

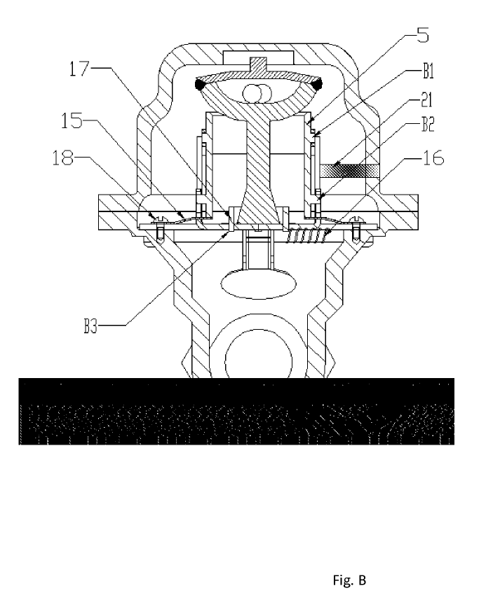

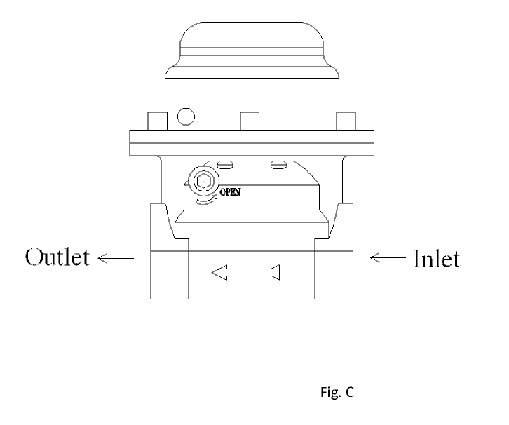

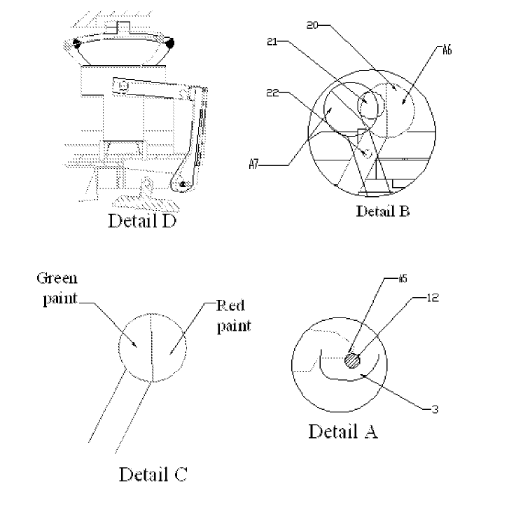

### CROSS-REFERENCE TO RELATED APPLICATIONS

This application claims the benefit of Provisional Application No. 61/107,356 filed Oct. 22, 2008.

### FIELD OF INVENTION

This invention relates generally to movement detectors and more particular for movement detectors, which include devices to shut off fluid flow.

### BACKGROUND OF THE INVENTION

The danger from earthquakes is well known. The ground trembles causing shock waves and movement to be sent from the point of the earthquake. This movement can be extremely severe. The force of a large earthquake can cause catastrophic damage. Buildings may be toppled, roads may buckle and bridges may collapse. Although earthquakes are better known for occurring in the western United States, some of the most severe earthquakes have occurred in the mid-west and even in the northeast.

While the earthquake itself may cause severe damage, the number of lives that can be lost as a result of fire and explosion is far greater. For example, if a resident has natural gas utility, a pipeline enters the home from a main pipeline from the utility company. In the event of an earthquake the regulator at the incoming pipeline may break and cause natural gas to be spewed into the air and generally in the vicinity of the house. If the gas is ignited an explosion can occur causing severe damage and catastrophic injury.

Thus, it is essential to keep the natural gas confined in the pipeline in order to minimize personal injury and property damage. Devices designed to keep natural gas confined to the pipeline had long been available to the general public. However, the public has seldom used these devices because they are generally unreliable. The devices are difficult to set so that they go off at the proper time. For example, Sharp, et al., U.S. Pat. No. 3,927,689, discloses an earthquake response safety valve assembly which relies upon pressure from the weight of a ball on a pin. Hansen, U.S. Pat. No. 5,482,074, discloses a safety cut-off device that utilizes a pendulum trigger assembly to keep a spool member in the open position. Simpson, U.S. Pat. No. 5,143,110, discloses a seismic gas shut-off valve in which a piston is suspended by seven steel balls that rest on the angled floor of an upper chamber and extend partially into the groove so that the ridge rests on the balls. Terrones, U.S. Pat. No. 4,535,796, discloses a seismic actuated shut-off valve that utilizes a severable link. These types of devices go off either too easily or not until extreme movement is reached, in which case the catastrophe may have already occurred without the device ever going off. Thus, in the event of an earthquake, which is not catastrophic in nature but which is significant to break a regulator, the devices may fail to go off. Additionally, if the earthquake is so slight that a regulator or pipeline would not be broken, and then such devices may go off causing the homeowner to find the devices unreliable. The homeowner would at the very least need to reset the device. However, because of the inconvenience of resetting the device, the homeowner might adjust the setting so that the device is activated only in the event of a catastrophic earthquake.

Additionally, it has been recognized that being able to reset the device is important. Sharp, et al., in U.S. Pat. No. 4,314,120 restructured their device so that it was resettable. Others have also attempted to make the resettable device. For example, in Kiesow, U.S. Pat. No. 4,103,697, a resettable structure is disclosed which incorporates a square groove with a pin needing a precise tolerance in order to work with an alignment means. The length of the shut off plunger must be precise because if it is too short the gas will flow and if it is too long the pin will not align with a square groove on the plunger. This device is expensive to manufacture as a result. Additionally, the square grove may make it difficult for the Kiesow device to activate the plunger and shut off the gas. Another example of an attempt to make a resettable earthquake activated shut off valve is found in Hansen, U.S. Pat. No. 2,054,563. However, in order to reset this device, the gas line must be turned off and then the device can be reset. Furthermore, Greer, U.S. Pat. No. 4,116,209 discloses a shock-actuated valve that has a tapered cylindrical valve gate suspended on an actuator pin. To reset the valve, the user must remove the closure from the stowage arm and engaging the retrieval loop in the valve head with a suitably bent wire. Greer, U.S. Pat. No. 4,745,939, is an improvement of Greer's earlier invention. This device has two valves aligned so that the actuator pins are at a 45-degree angle to one another. Each valve has a tether for resetting the valve by lifting the gate back onto the pin. Once activated, these devices are not easily reset.

Furthermore, the property damage from a major earthquake can be devastating. Historically, however, much of the worst damage comes after the earthquake is over because of fires that are started during or after the quake. Buildings are especially vulnerable to fire damage at these times because emergency services cannot get through the damaged or rubble-strewn roads to fight the fires. Natural gas supply pipes that are broken or damaged during an earthquake cause a serious danger of fire or explosion. Even a small leak in a gas line can accumulate enough gas in a building to cause a serious explosion if it is ignited.

In the great San Francisco earthquake of Apr. 18, 1906, the actual tremor lasted less than fifteen seconds, but the fires in the aftermath raged out of control for four days, causing more damage than the quake itself. This and similar tragedies point out the importance of having an emergency shutoff valve that will automatically stop the flow of gas into a building when it senses the vibrations of an earthquake of sufficient intensity that it could cause significant structural damage, such as the rupture of gas supply lines.

Recognizing this need, certain regulatory agencies such as the American National Standards Institute (ANSI), and the State Architect of California have established standards of performance for earthquake-actuated safety valves. Both the ANSI standard and the California Architectural Code (CAC) require the sensing means of the valve to actuate within 5 seconds when subjected to a horizontal, sinusoidal oscillation having a peak acceleration of 0.3 g (2.94 m/s.sup.2) and a period of 0.4 seconds (a frequency of 2.5 Hz). This corresponds to the type of vibrations experienced in an earthquake with a magnitude of 5.4 to 5.6 on the Richter scale.

The standards also require the valve to be insensitive to vibrations that are not typical of seismic activity. For this reason they require that the sensing means not actuate when subjected for five seconds to horizontal sinusoidal oscillation having:

1) Peak acceleration of 0.4 g (3.92 m/s.sup.2) and a period of 0.1 seconds (a frequency of 10 Hz);

2) Peak acceleration of 0.08 g (0.78 m/s.sup.2) and a period of 0.4 seconds (a frequency of 2.5 Hz);

3) Peak acceleration of 0.08 g (0.78 m/s.sup.2) and a period of 0.1 seconds (a frequency of 10 Hz).

This part of the standard is intended to ensure that the shutoff mechanism is not triggered by harmless vibrations such as a passing vehicle, loud noises, or even minor seismic activity that is not likely to result in structural damage or ruptured gas pipes.

The above background reveals what is and has been needed for a long time: a movement detector and a shut-off device that can be properly set to go off only if there is a danger of the gas line breaking causing leakage and which is easily adjustable and resettable.

### DISCUSSION OF THE PRIOR ART

U.S. Pat. No. 4,116,209 to Greer discloses a shock actuated shutoff valve that has a tapered cylindrical valve gate suspended on an actuator pin. When a shock of sufficient intensity dislodges the gate from the actuator pin, it falls by gravity into a tapered cylindrical valve seat sealing off fluid flow. The asymmetry of this design makes the valve more sensitive to vibrations from some directions than others. It also lacks a convenient reset mechanism.

U.S. Pat. No. 4,745,939 to Greer, et al., is an improvement on Greer's earlier patent. It has two of the above-described valves aligned so that their actuator pins are at a 45.degree. angle to one another. Each valve also has a tether for resetting the valve by lifting the gate back onto the pin. The redundancy in this design nearly eliminates the directional sensitivity of the earlier valve, but in so doing it doubles the cost and complexity.

U.S. Pat. Nos. 4,485,832 to Plemmons, et al., and 4,565,208 to Ritchie, et al., both disclose valves that have one or more balls riding in a circular track around a central chamber with a valve seat. A seismic shock dislodges one or more of the balls into the central chamber closing the valve. Both have a reset rod for returning the balls to the circular track. The Ritchie patent has the improvement that it has a special ramp-shaped obstruction along the track to urge the balls into the central chamber. These designs have been criticized for being too sensitive and prone to shutting off due to harmless vibrations. Also, the asymmetry of these designs makes them more sensitive to vibrations from some directions than others.

U.S. Pat. No. 4,911,029 to Banba, et al., discloses a check valve with an acceleration sensitive triggering mechanism. The triggering mechanism includes a ball, which normally rests on a stationary post. When subjected to a horizontal acceleration, the ball moves from the post to strike a reacting cylinder surrounding the post, which activates the valve to close. This valve has been criticized as being overly sensitive so that it will shut off due to harmless vibrations. It also lacks any positive means to keep the valve closed if it is tilted 45.degree. from the vertical after it is activated. This requires that the valve be strapped to a wall or other support to prevent tilting which complicates the installation of the valve.

### SUMMARY OF THE INVENTION

It is a generally object of this invention to provide a movement detector and shut-off device which will upon sufficient movement cause the free flow of fluid to stop.

It is a further object of this invention to provide such a device, which is easily adjustable and resettable.

It is a still further object of this invention to provide a movement detector and shut-off device, which is reliable.

It is a still further object of this invention to provide a movement detector and shut-off device, in which a natural gas seismic shut-off valve automatically shuts off gas service when an earthquake of a sufficient magnitude occurs at a location. An excess flow valve automatically shuts off gas service when a significant gas leak or overpressure surge occurs at a pipe or appliance located beyond the point where the valve is installed.

It is also an objective to make a shutoff valve that can be easily reset after it has been activated so that gas flow can be reestablished after the danger has passed and the gas pipes have been checked for leaks.

Yet another objective is that the shutoff valve, once it has been activated, should stay closed even if the structural damage to the building is so severe that the valve is tilted to an opening position.

### BRIEF DESCRIPTION OF THE DRAWINGS

In this section a brief explanation is given regarding the components arrangements and views and also the frame and the installation conditions and some points associated with assembling of all the parts.

Fig. A: it is an indication of the frame from the side view and the way of holder lockage while the valve is open and after acting thereof under the close state and assembly of the frame internal parts and the cap thereof.

Fig. B: it is the front view and the method of assembling the spring and the screws to fix the chassis onto the frame and the method of pinning and connecting the tower side ring.

B1: it is the method of placement of the spring under the tower side ring.

B2: it is the placement of the spiral spring around the shaft. The responsibility of such spring is due pressure of the disc onto the disc seating and better sealing thereof

Fig. C: it is a location of installation the activation switch or resetting the rotation display key embedded onto the frame

Detail A: it shows the method of holder lockage with the catch

Detail B: it shows the method of placement of red and green colors opposite of the display; each of such colors shows either the close of open states of the valve.

### DETAILED DESCRIPTION OF THE INVENTION

Disclosed is a shut-off valve, which acts automatically, and has a fully mechanical performance with respect to the loosing of the tower-shape part balance under the effect of the special acceleration, which is arisen from the quakes waves or serious vibrations, while such vibrations are mainly resulted from collision or effusion. A static tower has been applied for the main core of this part of the valve which loses balance state under the effect of collision and bounces to the neighboring part, which results in release of the catch and blockage of the gas passing channel. Such matter will eventually result in gas shut-off. A disc and its holder and the pressure of a spring have been embedded for the sealing therein.

In the preferred embodiment, the present invention discloses a security valve in order to prevent the gas leakage, which is used with respect to damages imposed to the gas pipe inside the residential or commercial unit and eventually prevent conflagration. The brief method of action thereof is as followed.

This device is divided into two important parts, one of which is a one-way valve known as the check valve, for which a mechanism has been designed to activate thereof. The second part may be considered as a quake waves' sensor and the reaction mechanism thereto. For the main core of this part of the valve the static tower type has been used, which loses balance state under the effect of collision and bounces to the neighboring part, which results in release of the catch and blockage of the gas passing channel. This valve has been designed with respect to American Institute Standards, namely ANSI Z21.21, ASCE 25-9729 1976, and using the American Inventions Registration Documents, including 8, 112, 764 Sep. 5 2000 & 3, 965, 917 Jul. 29 1976 of the California valve, which one of the features of such valves is using the swing check valve. Safety shut-off valves can be automated or manually activated. Both types of devices are designed and manufactured to meet most industry specifications. Safety shut-off valves are used in a variety of applications. For example, a water shut off valve can be used in a building to prevent further water damage caused by a burst pipe. A fuel shut off valve is important when using machinery that may be susceptible to high heat and possible fires. A gas shut off valve is an important safety feature in the event of a leak created by an earthquake. Most safety shut-off valve systems must be reset once the shut-off valve has been activated. Safety shut-off valves should adhere to standards established by the American Society of Mechanical Engineers (ASME).

Swing check valve includes disc seating, holder, shaft, spring, disc, shell and frame. Due to the high level loosening between the holder and the disc and shaft and the respective soft disc specifications a quite desirable sealing is generated which causes that the surface of the valve to keep the such sealing capability to a significant level, due to the deformation made to the valve frame resulted of collision or the weight of destructed structure imposed to the valve, provided that such deformation would be with respect to an extent which does not remove the loosening existed among the aforementioned components, although the spring force compensates for such defect to some extent. Other features of the disk comprises generating a better sealing in the direction, it shuts the gas due to the gas pressure on the disc on the surface of the seating thereof. There higher the gas pressure, the better the sealing will be. However, such pressure may be increased to the extent that the frame could bear the same pressure.

The other part of the valve is the set of actuator or the receiving & reaction set against the quake waves. The components thereof include the set of tower, side ring, catch lever, under-ring spring, chassis, the screws to install the chassis onto the frame, tower base bush, whose performance is in a way that when the quake acceleration reaches a certain measure then the tower looses its balance and collides with the tower header side part, which the tower weight will result in motion of the ring towards the tower leg. Eventually, the ring connection in pins with the catch lever results in lever tip displacement-which has the responsibility of keeping the holder. Releasing of the lever and eventually seating of the disc on the sealing place and blockage of the gas-passing channel will be resulted accordingly. The point which shall be noted thereof is that the tower base seating on the chassis cross section, for which if the diameter of this cross section is bigger—presuming that the quake waves as fixed, then we will consider that the tower will loose its state of balance slower. Also it is possible to consider the same presumption for the smaller cross section as effective, in which case the tower balance will be lost faster with respect to the previous states.

The other factor is the tower height, which displaces the tower's center of gravity, which has a direct effect on the tower performance, while it may be effective on the tower header global sections, from the diameter and weight points of view. As it may be known, the quake waves are occurred with a low level of acceleration but in long term are more destructive compared to those quake waves which hade higher accelerations which are occurred in a short while, as the continuous waves with lo energy and in long term will result in loosening the connections at the buildings and engineered structures, for such cases the wedges inside the tower are used, which result in loss of the tower balance and it also prevents the tower quake frequency to the be the same as for the earthquake. The point which should be mentioned here is the balance of the valve in the time of installation, otherwise the valve will not act under the certain acceleration and time arranged for. However, it should be noted that such failure in balance will not result in valve delayed action, and the valve will only shuts the gas passing channel in a lower acceleration and shorter while, as the tower will loose its state of balance faster, which may consider as a reliance coefficient for itself.

Finally the valve open and close states indication equipments may be considered. Such equipments include the display, which has been made from optical fibers, and a board, which is painted in two green and red parts, and a spring, which places the board under the states.

With particular reference to fig. A, where the main view and the arrangements of most of the parts have been indicated, the part no. 1 of the valve frame, or the main part thereof associates with the one-way valve, where the A1 seating angle is clearly observable, which helps that the disc surface to completely seat onto its sealing location.

This angle is 5°, which the disc and holder weights—besides spring force, perform the matter of sealing. In the view the status of holder (9), shaft (10) and disc (8) have been indicated which show the set open/close states, as A2 and A3 positions have been shown for the close and open states, respectively. The A4 & A5 positions are for the valve connection to the pipeline, which may be considered in three forms of grooved, flanged, and clamped.

At the second part—that includes the method of tower assembling method (4) and catch lever (3) and tower side ring (5) and all the actuator parts on the chassis (6) as shown thereof, the cap (2) is assembled using the screws (7) and the sealing bushes (14). Here we again explain the actuator method of working using the parts numbers.

Assuming that the quake acceleration and frequency to be in a way that the tower (4) shall loose its balance state, which by its tilting and falling onto the ring (5) and the weight pressure on this part (5) to the lower part, the chassis (6) starts moving, which the method of lever (3) connection by pin (11) and rotation around such pin results in pin (12) rotational movement in anti-clockwise direction and eventually release of the holder (9) and then the disc will be placed in A2 position by the Fig B. spring force pressure, and so it prevents the gas flow through the pipeline. It should be mentioned that the set of holder (9) and disc (8) are assembled onto the frame (1) by the shaft (10).

In view “a” the method of set lockage or keeping it under active conditions in A5 status indicates the way of holder (9) placement on the pin (12).

In view “b” the indicator set shows us the A6 status, i.e. the closed status, which in case you look at the “c” view, the board (20) has been divided into two part, a red and a green painted part, a spiral spring keeps the board (20) always under A6 status, and places the red color against the display under A7 status.

In fig. B you see the spring no. 15 position, for which the method of assembling is in a way that it imposes a lifting force to the ring base (5). The performance of this part (15) may be observed during the resetting of the valve, and when the ring (5) is pushed upward, due to the B1 & B2 status pins and the lever (3) rotational motion around the pin (11) in clockwise direction it places the pin (12) in a position that has been indicated in Detail D. in Fig. B the number of screws (18) has been considered as 4, which both fixes the spring (15) into its place and also fixes the actuator set onto the chassis (6) assembled onto the frame.

In this view we reach the bush (17), which is riveted onto the chassis from the holder set side—the B3 status. The responsibility of such bush has been considered to keep the tower (4) at the chassis's center (6) and prevention of tower (6) bottom slipping during the earthquakes waves traversing acceleration. Such tower bottom slipping due to the tower bottom small cross section and placement of such tower on a smooth metal surface will be considered as a factor under which the tower bottom may not place in its location under various quake accelerations.

In Fig. C you observe the appearance of the valve and the signs engraved thereto. The at such view the gas inlet/outlet have been shown, as well as the display for which the green and red colors shows the valve open and shut-off states, respectively. There it may also be seen a sign which has been engraved into the frame in order to open and re-activation of the valve.

This valve is specifically designed to shut off the flow of natural gas into a building in the even of a major earthquake. However, the valve might also be used for a number of other applications, with or without modification, to shut off the flow of a fluid in the event of a predetermined level of shock or oscillation. For instance, the valve may be used to shut off the flow of water into a building or it may be used to shut off the flow of fluids or gases in an industrial process in the event of an earthquake, explosion or other shock.

The valve, used as an earthquake or shock detector, may be incorporated into a larger system to shut off a multitude of services. The valve, for instance, could be used to generate a pneumatic or electrical signal to a system which would shut off any or all of the following services: natural gas supply, water supply, electricity, gas or fluid flow or power to industrial processes. Such a system could even be used to turn on emergency services such as warning lights or sirens or backup power from batteries or a generator in case of an earthquake.

Although the preceding description and the accompanying drawings contain many specifics, these should not be construed as limiting the scope of the invention but merely as illustrations of the presently preferred embodiments of this invention. Many variations are possible within the scope of the invention. Thus the scope of the invention should be determined by the appended claims and their legal equivalents rather than by the examples given.

What is claimed is:

1. A seismic shutoff valve comprising:
A static tower which loses balance state under an effect of collision and bounces to a neighboring part, which results in release of a catch and causes blockage of gas passing channel; and
a disc in combination with a disk holder and a spring to seal the channel.

2. The seismic shutoff valves of claim 1 further comprising: a one-way valve and a quake waves' sensor.
